(19) United States
(12) Patent Application Publication
(10) Pub. No.: US 2024/0390999 A1
(43) Pub. Date: Nov. 28, 2024

(54) TUBE CUTTER WITH ADJUSTABLE SPRING-BIASED HOLDER

(71) Applicant: Bing-Cheng Liao, Changhua County (TW)

(72) Inventor: Bing-Cheng Liao, Changhua County (TW)

(21) Appl. No.: 18/665,794

(22) Filed: May 16, 2024

(30) Foreign Application Priority Data
May 26, 2023 (TW) 112119714
Oct. 6, 2023 (TW) 112210854

(51) Int. Cl. B23D 21/08

(52) U.S. Cl. CPC B23D 21/08

(57) ABSTRACT

A tube cutter includes a main body, a holder mounted on the main body, two rollers rotatably mounted on the main body, a cutting wheel rotatably mounted on the holder, a slide received in a receiving space of the holder, a guide bolt screwed through the slide, and two elastic members biased between the slide and the holder. The slide is driven by the guide bolt and drives the holder to slide forward and backward. The holder is provided with a screw hole for screwing an elasticity adjusting bolt. When the elasticity adjusting bolt is screwed into the screw hole and presses the slide, the holder and the slide are adapted to cut a hard tube. When the elasticity adjusting bolt is unscrewed from the screw hole, the holder and the slide are adapted to cut a soft tube.

### BACKGROUND OF THE INVENTION

### Field of the Invention

The present invention relates to a cutter and, more particularly, to a tube cutter for cutting a tube.

### Description of the Related Art

A first conventional tube cutter in accordance with the prior art shown in FIGS. 14 and 15 comprises a main body 80, a holder 81 slidably mounted on the main body 80, two rollers 83 rotatably mounted on the main body 80, a cutter 84 mounted on the holder 81, and a driving mechanism 82 mounted on the main body 80. A hard tube 1 is located between the rollers 83 and the cutter 84. The main body 80 has a through hole 85. The holder 81 has a screw hole 86. The driving mechanism 82 includes a threaded rod 87 rotatably mounted in the through hole 85 and screwed through the screw hole 86. Thus, the cutter 84 is used to cut the hard tube 1. However, the rollers 83 are not elastic, so that when the cutter 84 is used to cut a soft tube, the soft tube is easily deformed by the rollers 83.

A second conventional tube cutter in accordance with the prior art shown in FIGS. 16 and 17 comprises a main body 90, a holder 91 slidably mounted on the main body 90, a roller carrier 93 slidably mounted on the main body 90, two rollers 94 rotatably mounted on the roller carrier 93, two compression springs “T” biased between the main body 90 and the roller carrier 93, a cutter 95 mounted on the holder 91, and a driving mechanism 92 mounted on the main body 90. A soft tube 2 is located between the rollers 94 and the cutter 95. The main body 90 has a through hole 96. The roller carrier 93 has a through hole 97. The holder 91 has a screw hole 98. The driving mechanism 92 includes a threaded rod 99 rotatably mounted in the through hole 96 of the main body 90 and the through hole 97 of the roller carrier 93, and screwed through the screw hole 98 of the holder 91. In operation, when the cutter 95 is used to cut the soft tube 2, the roller carrier 93 is pressed by the compression springs “T”, so that the soft tube 2 and the roller carrier 93 are kept at an elastically pressed state, without having to regulate the tension between the soft tube 2 and the cutter 95. Thus, the soft tube 2 is cut smoothly. However, the rollers 94 are kept elastic by the compression springs “T”, so that the cutter 95 is only used to cut the soft tube 2, and cannot be used to cut a hard tube.

### BRIEF SUMMARY OF THE INVENTION

The primary objective of the present invention is to provide a tube cutter that is switched easily to cut a hard tube or a soft tube. The tube cutter has an adjustable spring-biased holder.

In accordance with one embodiment of the present invention, there is provided a tube cutter comprising a main body, a holder, a guide bolt, two rollers, a cutting wheel, a slide, and two elastic members. The two rollers are rotatably mounted on a first side of the main body. The holder is mounted on a second side of the main body. The cutting wheel is rotatably mounted on the holder and aligns between the two rollers. The holder has a lower end provided with a receiving space. The slide is received in the receiving space. The slide has a width equal to that of the receiving space and has a length less than that of the receiving space. The guide bolt is screwed through the slide. The slide is driven by the guide bolt which is rotated normally and reversely and drives the holder to slide forward and backward. The two elastic members are mounted in the receiving space of the holder and biased between the slide and the holder. The holder is provided with a screw hole corresponding to the slide. An elasticity adjusting bolt is screwed through the screw hole of the holder. When the elasticity adjusting bolt is screwed into the screw hole of the holder and presses the slide, the holder and the slide are combined integrally so that the holder and the slide are adapted to cut a hard tube. When the elasticity adjusting bolt is unscrewed from the screw hole of the holder, the holder and the slide are pressed by the two elastic members and kept under an elastic condition so that the holder and the slide are adapted to cut a soft tube.

In accordance with another embodiment of the present invention, there is provided a tube cutter comprising a main body, a holder, a guide bolt, two rollers, a cutting wheel, a slide, and two elastic members. The two rollers are rotatably mounted on a first side of the main body. The holder is mounted on a second side of the main body. The cutting wheel is rotatably mounted on the holder and aligns between the two rollers. The holder has a lower end provided with a receiving space. The slide is received in the receiving space. The slide has a width equal to that of the receiving space and has a length less than that of the receiving space. The guide bolt is screwed through the slide. The slide is driven by the guide bolt which is rotated normally and reversely and drives the holder to slide forward and backward. The two elastic members are mounted in the receiving space of the holder and biased between the slide and the holder. The main body is provided with two recessed portions or hollow portions corresponding to the receiving space of the holder. The holder is provided with a first indication line corresponding to a front position of the slide and a second indication line corresponding to a rear position of the slide. Thus, a user observes through the two recessed portions or the two hollow portions and clearly sees if the front position and the rear position of the slide align with the first indication line and the second indication line respectively, to adjust an elastic compression of the two elastic members to the optimum value, to provide the best judgment basis for a beginner or an inexperienced person. The first indication line and the second indication line are arranged above the receiving space of the holder.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a tube cutter in accordance with the first preferred embodiment of the present invention.

FIG. 2 is an exploded perspective view of the tube cutter as shown in FIG. 1.

FIG. 3 is a cross-sectional view of the tube cutter as shown in FIG. 1.

FIG. 4 is a perspective view of a tube cutter in accordance with the second preferred embodiment of the present invention.

FIG. 5 is an exploded perspective view of the tube cutter as shown in FIG. 4.

FIG. 6 is a cross-sectional view of the tube cutter as shown in FIG. 4.

FIG. 7 is a perspective view of a tube cutter in accordance with the third preferred embodiment of the present invention.

FIG. 8 is an exploded perspective view of the tube cutter as shown in FIG. 7.

FIG. 9 is a cross-sectional view of the tube cutter as shown in FIG. 7.

FIG. 10 is a schematic operational view of the tube cutter as shown in FIG. 3 in cutting of a hard tube.

FIG. 11 is a schematic operational view of the tube cutter as shown in FIG. 3 in cutting of a soft tube.

FIG. 12 is a schematic operational view of the tube cutter as shown in FIG. 11 in a stepless state for adjusting the elastic force.

FIG. 13 is another schematic operational view of the tube cutter as shown in FIG. 11 in a stepless state for adjusting the elastic force.

FIG. 14 is a perspective view of a first conventional tube cutter in accordance with the prior art.

FIG. 15 is a cross-sectional operational view of the first convention tube cutter as shown in FIG. 14.

FIG. 16 is a perspective view of a second conventional tube cutter in accordance with the prior art.

FIG. 17 is a cross-sectional operational view of the second convention tube cutter as shown in FIG. 16.

### DETAILED DESCRIPTION OF THE INVENTION

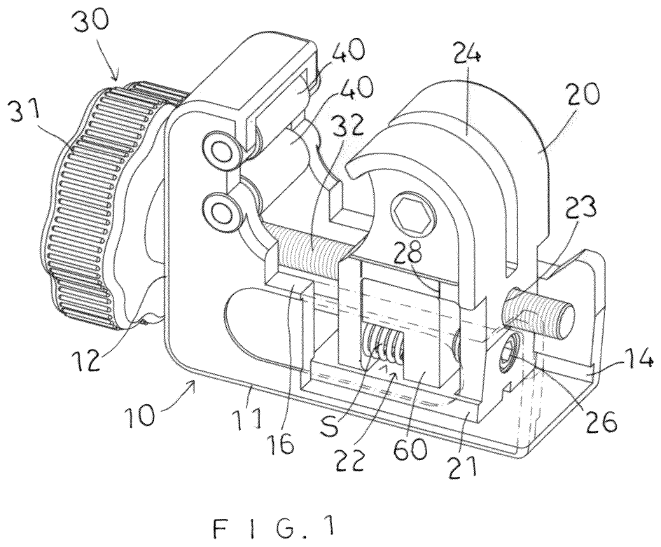

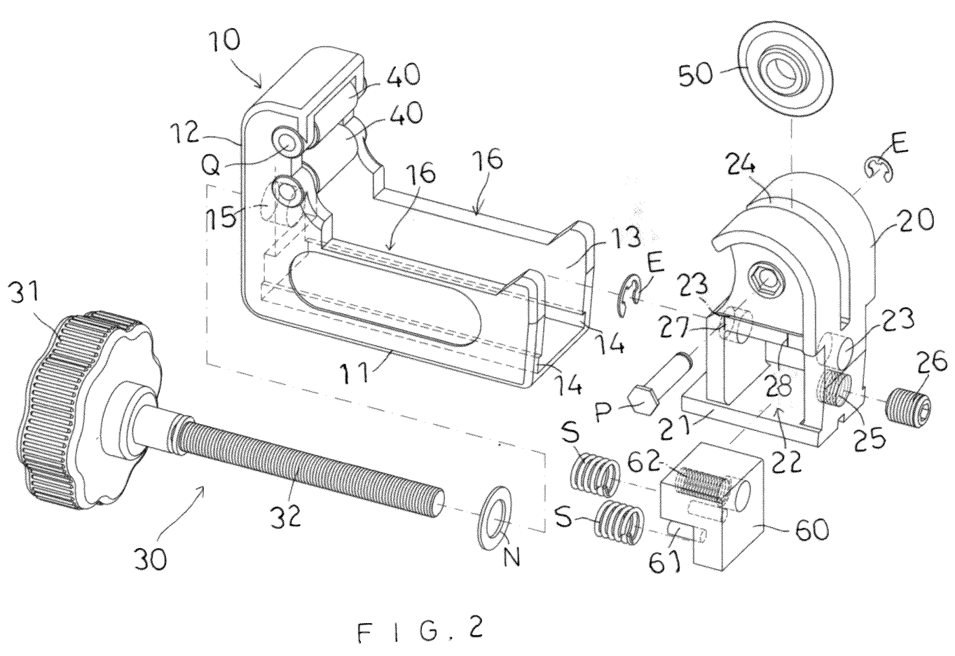

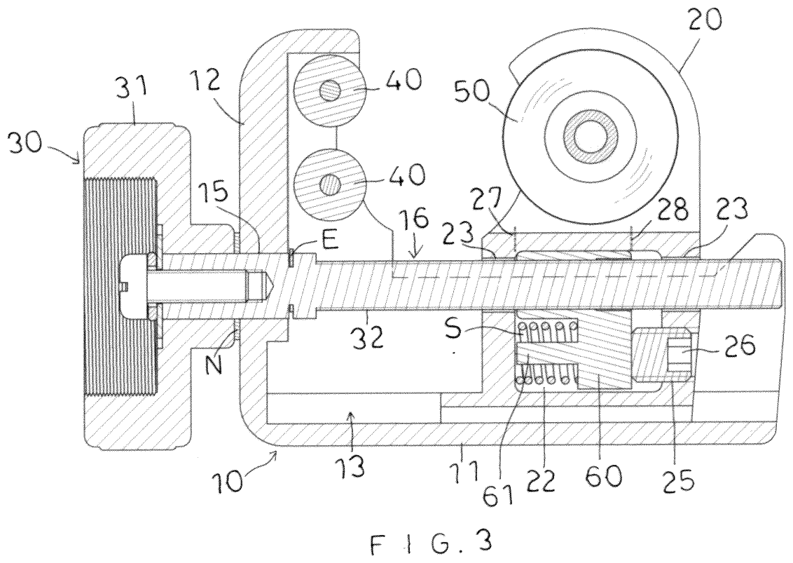

Referring to the drawings and initially to FIGS. 1-3, a tube cutter in accordance with the first preferred embodiment of the present invention comprises a main body 10, a holder 20, a guide bolt 30, two rollers 40, a cutting wheel 50, and a slide 60.

The main body 10 has a substantially L-shaped profile and includes a horizontal portion 11 and a vertical portion 12 located at a side of the horizontal portion 11. The horizontal portion 11 is provided with a horizontal receiving channel 13, and the holder 20 is slidably mounted in the horizontal receiving channel 13. The main body 10 is provided with two slideways 14 formed in two sidewalls of the horizontal receiving channel 13. The horizontal portion 11 is provided with a first through hole 15 corresponding to the vertical portion 12, and the guide bolt 30 extends through the first through hole 15. Two pivot shafts Q are mounted on two sidewalls of the vertical portion 12, and the two rollers 40 are rotatably mounted on the two pivot shafts Q. The main body 10 is provided with two recessed portions 16 located above the horizontal portion 11 and corresponding to the horizontal receiving channel 13.

The holder 20 is received in the horizontal receiving channel 13 of the main body 10. The holder 20 is provided with two sliding rails 21 slidably mounted in the two slideways 14, so that the holder 20 is moved forward and backward in the horizontal receiving channel 13 of the main body 10. The holder 20 has a lower end provided with a receiving space 22 for receiving the slide 60. The holder 20 is provided with two second through holes 23 located at two sidewalls of the receiving space 22 and aligning with the first through hole 15 of the main body 10, and the guide bolt 30 extends through the two second through holes 23. The holder 20 has an upper end provided with a slot 24 corresponding between the two rollers 40, and the cutting wheel 50 is received in the slot 24 of the holder 20. The cutting wheel 50 is rotatably mounted between two sidewalls of the slot 24 by a screw “P” and a snap ring “E” so that the cutting wheel 50 is rotated freely. The holder 20 is provided with a screw hole 25 corresponding to the slide 60. An elasticity adjusting bolt 26 is screwed into the screw hole 25. The holder 20 is provided with a first indication line 27 corresponding to a front position of the slide 60 and a second indication line 28 corresponding to a rear position of the slide 60, so that a user observes through the two recessed portions 16 and clearly sees if the front position and the rear position of the slide 60 align with the first indication line 27 and the second indication line 28 respectively, to adjust an elastic compression (or tension) to the optimum value. The first indication line 27 and the second indication line 28 are arranged above the receiving space 22.

The guide bolt 30 has a first end provided with a rotation portion 31 protruding from the first through hole 15 of the main body 10 and a second end provided with an external thread 32 screwed through the slide 60. In assembly, the external thread 32 of the guide bolt 30 initially extends through the first through hole 15 of the main body 10 and a front one of the two second through holes 23 of the holder 20, is then screwed through the slide 60, and then extends through a rear one of the two second through holes 23 of the holder 20. A washer “N” is mounted on the guide bolt 30 and located between rotation portion 31 and the main body 10. A snap ring “E” is secured on the guide bolt 30 and presses the main body 10 to prevent the guide bolt 30 from being detached from the main body 10.

The two rollers 40 are rotatably mounted on the vertical portion 12 of the main body 10 by the two pivot shafts Q, so that the two rollers 40 are rotated freely in the vertical portion 12.

The cutting wheel 50 is rotatably mounted in the slot 24 of the holder 20 by the screw “P” which extends through the holder 20.

The slide 60 has an inverted L-shaped profile. The slide 60 has a width equal to that of the receiving space 22 and has a length less than that of the receiving space 22. Two elastic members “S” are mounted in the receiving space 22 of the holder 20 and biased between the slide 60 and the holder 20. The slide 60 is provided with two positioning shafts 61 for mounting the two elastic members “S”. Each of the two elastic members “S” has two legs pressing the slide 60 and the holder 20 respectively. The slide 60 has a center provided with a screw hole 62 corresponding to the external thread 32 of the guide bolt 30. Thus, the external thread 32 of the guide bolt 30 is screwed through and rotated in the screw hole 62 of the slide 60 normally or reversely, so that the slide 60 is moved in the receiving space 22 forward or backward. In practice, when the front position and the rear position of the slide 60 align with the first indication line 27 and the second indication line 28 respectively, the elastic compression (or tension) of each of the two elastic members “S” is adjusted to the optimum value.

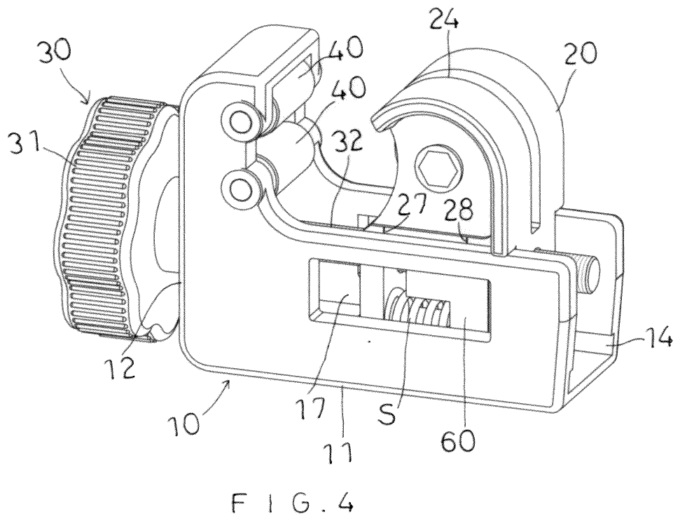

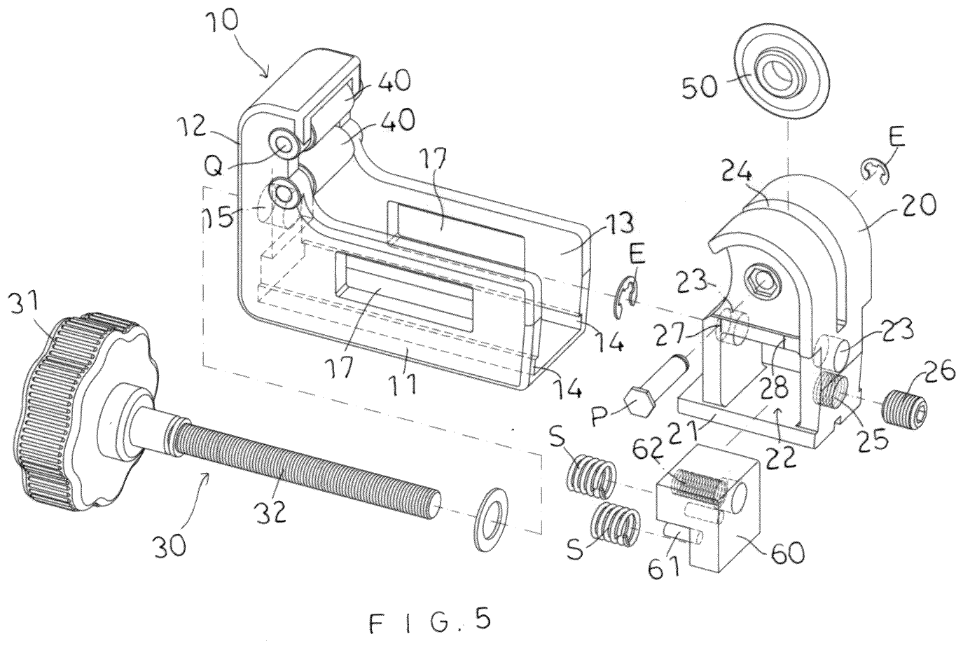

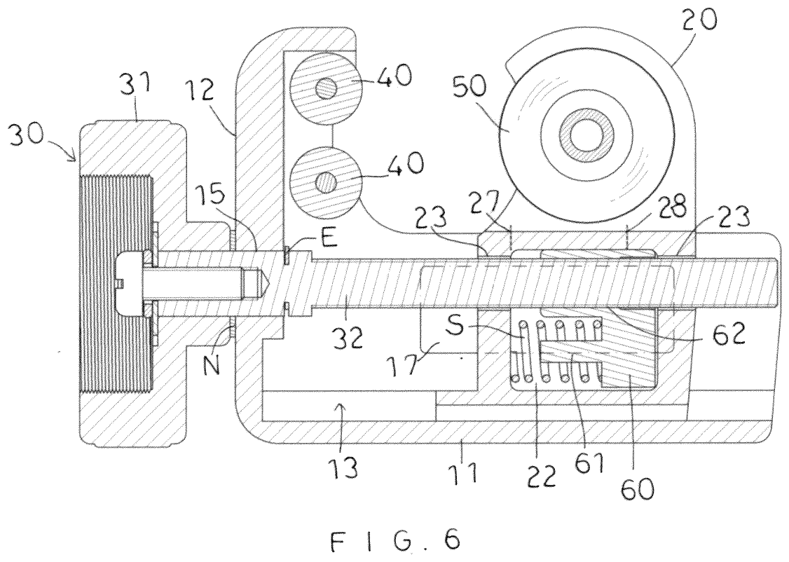

Referring to FIGS. 4-6, in accordance with the second preferred embodiment of the present invention, the main body 10 is provided with two hollow portions 17 located above the horizontal portion 11. Thus, the user observes through the two hollow portions 17 and clearly sees if the front position and the rear position of the slide 60 align with the first indication line 27 and the second indication line 28 respectively, to adjust the elastic compression (or tension) of each of the two elastic members “S” to the optimum value.

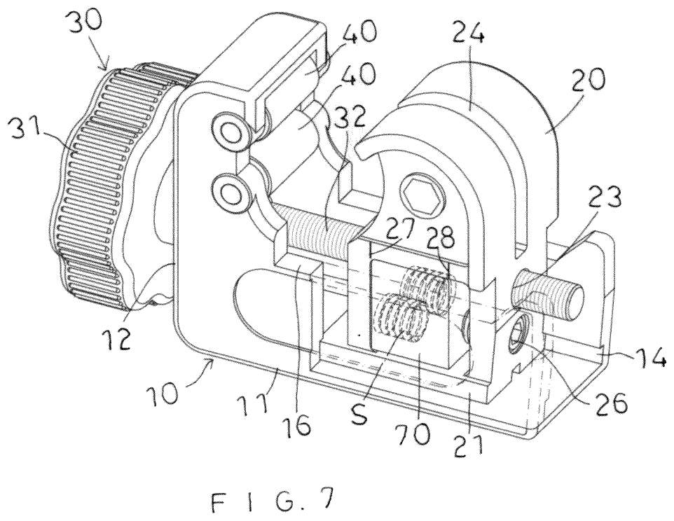

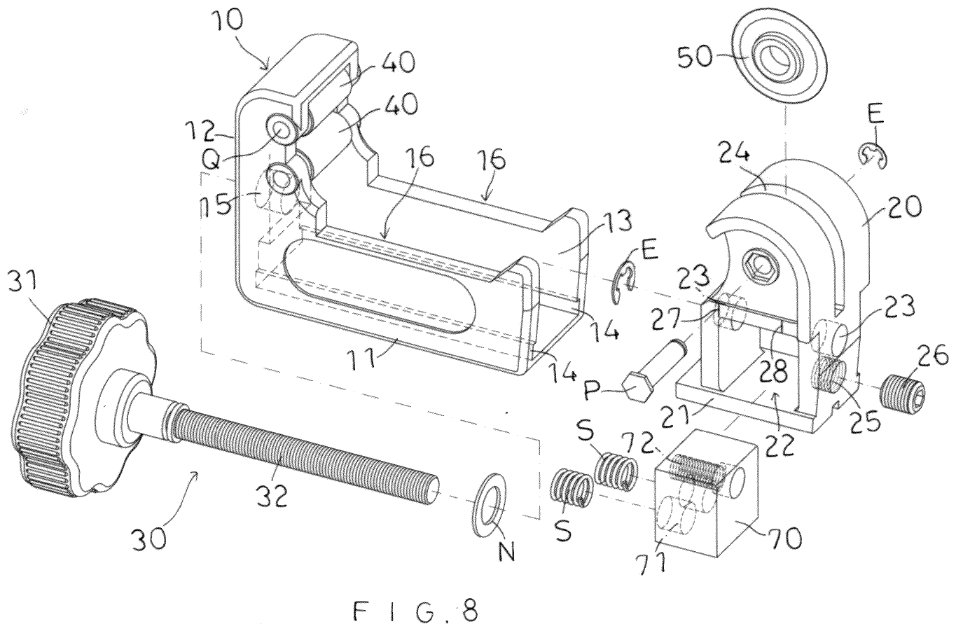

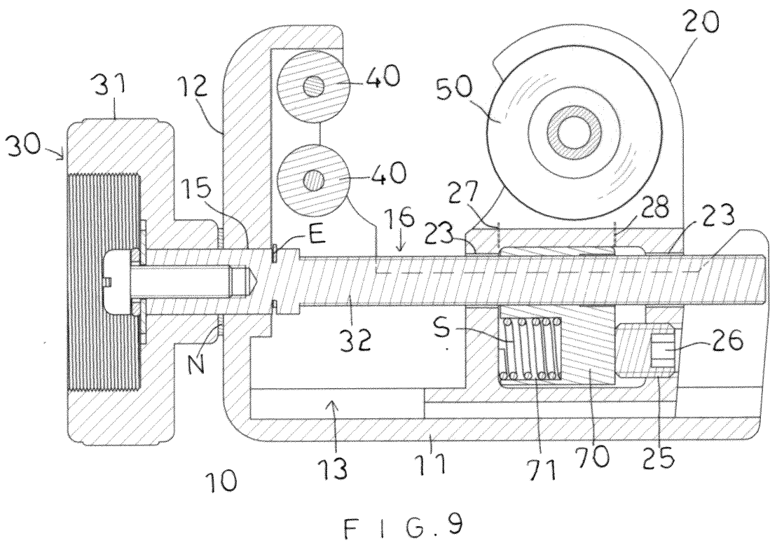

Referring to FIGS. 7-9, in accordance with the third preferred embodiment of the present invention, the slide 70 has a block or lump shape. The slide 70 has a width equal to that of the receiving space 22 and has a length less than that of the receiving space 22. Two elastic members “S” are mounted in the receiving space 22 of the holder 20 and biased between the slide 70 and the holder 20. The slide 70 is provided with two spring grooves 71 for mounting the two elastic members “S”. Each of the two elastic members “S” has two legs pressing the slide 70 and the holder 20 respectively. The slide 70 has a center provided with a screw hole 72 corresponding to the external thread 32 of the guide bolt 30. Thus, the external thread 32 of the guide bolt 30 is screwed through and rotated in the screw hole 72 of the slide 70 normally or reversely, so that the slide 70 is moved in the receiving space 22 forward or backward.

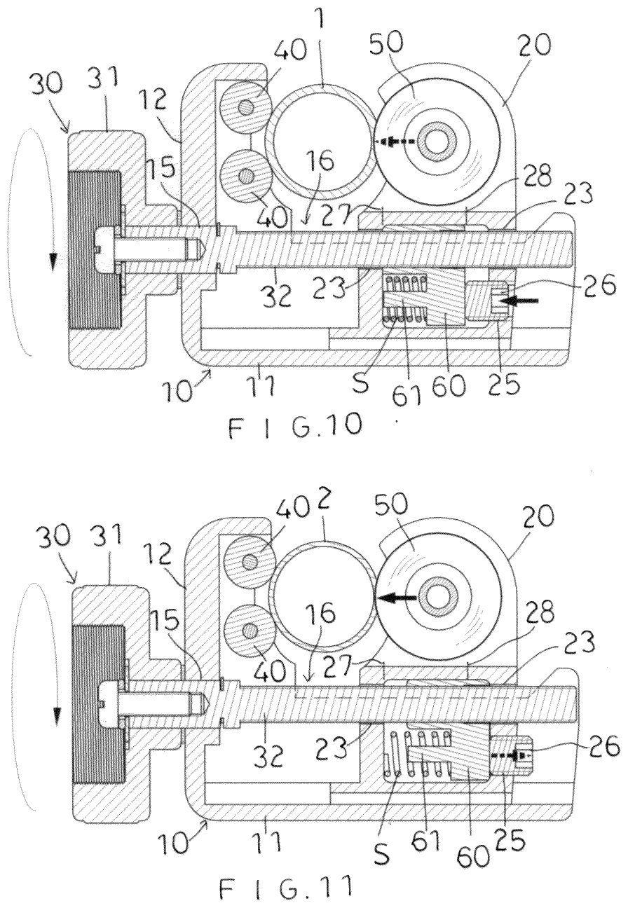

In operation, referring to FIG. 10 with reference to FIGS. 1-3, when the tube cutter is used to shear a hard tube 1, the hard tube 1 is inserted between the two rollers 40 and the cutting wheel 50, so that the two rollers 40 and the cutting wheel 50 are arranged under a three-point contact condition to support the hard tube 1 steadily. When the elasticity adjusting bolt 26 is screwed into the screw hole 25 and presses the slide 60, the holder 20 and the slide 60 are combined integrally and integrated into one to cut the hard tube 1. Then, the guide bolt 30 is further rotated. In such a manner, the user observes through the two recessed portions 16, and when the front position and the rear position of the slide 60 align with the first indication line 27 and the second indication line 28 respectively, the elastic compression (or tension) of each of the two elastic members “S” is adjusted to the optimum value, to provide the best judgment basis for a beginner or an inexperienced person. Thus, even a beginner or an inexperienced person can easily judge if the front position and the rear position of the slide 60 align with the first indication line 27 and the second indication line 28 respectively.

Alternatively, referring to FIG. 11 with reference to FIGS. 1-3, when the tube cutter is used to shear a soft tube 2, the soft tube 2 is inserted between the two rollers 40 and the cutting wheel 50, so that the two rollers 40 and the cutting wheel 50 are arranged under a three-point contact condition to support the soft tube 2 steadily. When the elasticity adjusting bolt 26 is unscrewed and loosened from the screw hole 25, the holder 20 and the slide 60 are pressed by the two elastic members “S” and kept under an elastic condition when the soft tube 2 is cut, to prevent the soft tube 2 from being deformed during the cutting process. Then, the guide bolt 30 is further rotated. In such a manner, the user observes through the two recessed portions 16, and when the front position and the rear position of the slide 60 align with the first indication line 27 and the second indication line 28 respectively, the elastic compression (or tension) of each of the two elastic members “S” is adjusted to the optimum value. Thus, even a beginner or an inexperienced person can easily judge if the front position and the rear position of the slide 60 align with the first indication line 27 and the second indication line 28 respectively.

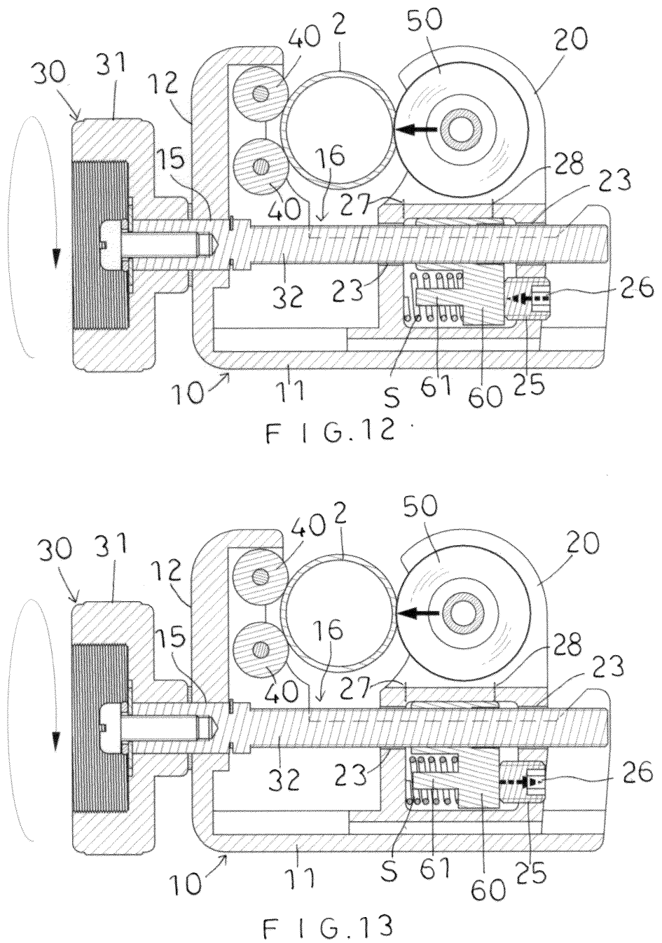

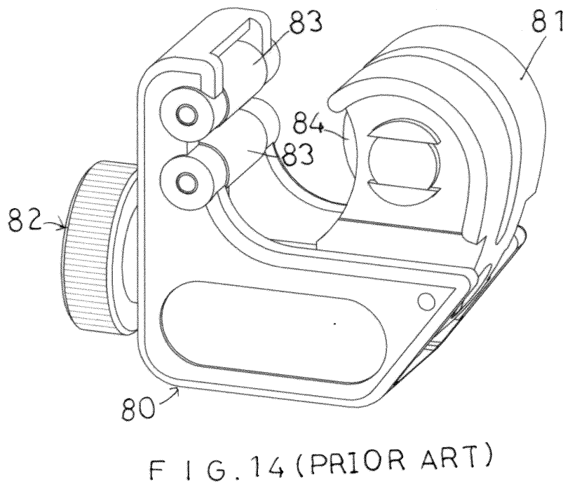

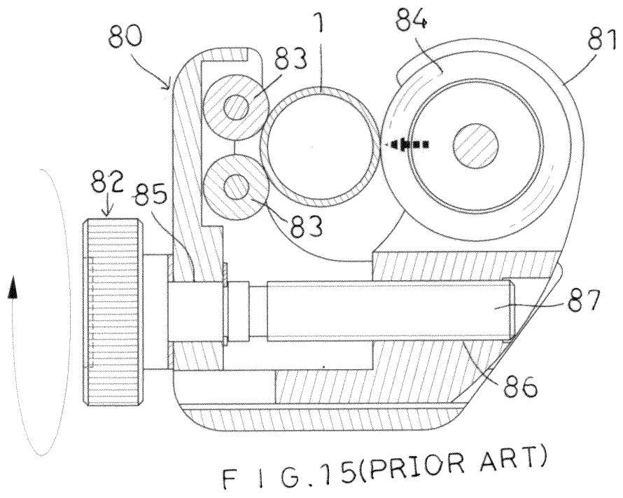

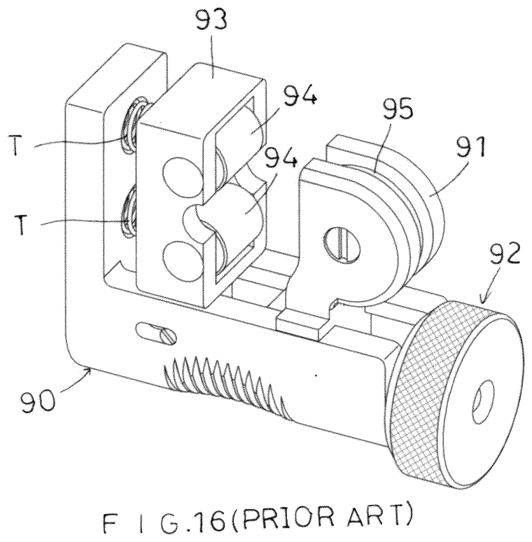

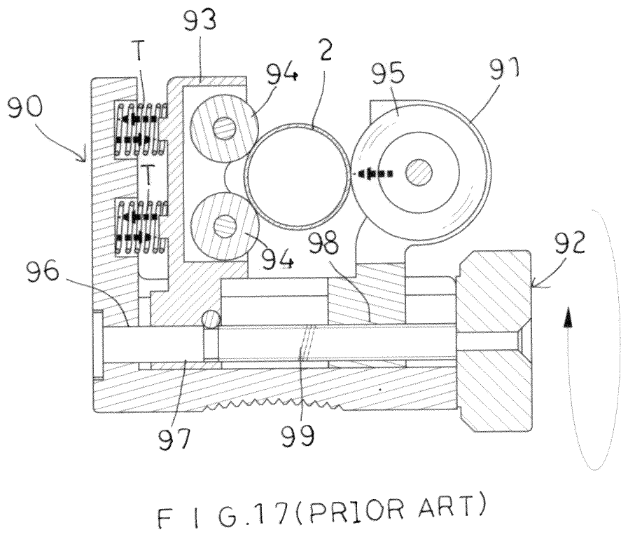

Referring to FIGS. 12 and 13 with reference to FIGS. 1-3, when the elasticity adjusting bolt 26 is screwed into or unscrewed from the screw hole 25, the elastic force of the two elastic members “S” applied on the holder 20 is regulated in a stepless manner. Then, the guide bolt 30 is further rotated. In such a manner, the user observes through the two recessed portions 16, and when the front position and the rear position of the slide 60 align with the first indication line 27 and the second indication line 28 respectively, the elastic compression (or tension) of each of the two elastic members “S” is adjusted to the optimum value. Thus, even a beginner or an inexperienced person can easily judge if the front position and the rear position of the slide 60 align with the first indication line 27 and the second indication line 28 respectively.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A tube cutter comprising:
a main body, a holder, a guide bolt, two rollers, a cutting wheel, a slide, and two elastic members;
wherein:
the two rollers are rotatably mounted on a first side of the main body;
the holder is mounted on a second side of the main body;
the cutting wheel is rotatably mounted on the holder and aligns between the two rollers;
the holder has a lower end provided with a receiving space;
the slide is received in the receiving space;
the slide has a width equal to that of the receiving space and has a length less than that of the receiving space;
the guide bolt is screwed through the slide;
the slide is driven by the guide bolt which is rotated normally and reversely and drives the holder to slide forward and backward;
the two elastic members are mounted in the receiving space of the holder and biased between the slide and the holder;
the holder is provided with a screw hole corresponding to the slide;
an elasticity adjusting bolt is screwed through the screw hole of the holder;
when the elasticity adjusting bolt is screwed into the screw hole of the holder and presses the slide, the holder and the slide are combined integrally so that the holder and the slide are adapted to cut a hard tube; and
when the elasticity adjusting bolt is unscrewed from the screw hole of the holder, the holder and the slide are pressed by the two elastic members and kept under an elastic condition so that the holder and the slide are adapted to cut a soft tube.

2. The tube cutter as claimed in claim 1, wherein the slide has an inverted L-shaped profile, and the slide is provided with two positioning shafts for mounting the two elastic members.

3. The tube cutter as claimed in claim 1, wherein the slide has a block shape, and the slide is provided with two spring grooves for mounting the two elastic members.

4. A tube cutter comprising:
a main body, a holder, a guide bolt, two rollers, a cutting wheel, a slide, and two elastic members;
wherein:
the two rollers are rotatably mounted on a first side of the main body;
the holder is mounted on a second side of the main body;
the cutting wheel is rotatably mounted on the holder and aligns between the two rollers;
the holder has a lower end provided with a receiving space;
the slide is received in the receiving space;
the slide has a width equal to that of the receiving space and has a length less than that of the receiving space;
the guide bolt is screwed through the slide;
the slide is driven by the guide bolt which is rotated normally and reversely and drives the holder to slide forward and backward;
the two elastic members are mounted in the receiving space of the holder and biased between the slide and the holder;
the main body is provided with two recessed portions or hollow portions corresponding to the receiving space of the holder;
the holder is provided with a first indication line corresponding to a front position of the slide and a second indication line corresponding to a rear position of the slide;
a user observes through the two recessed portions or the two hollow portions and clearly sees if the front position and the rear position of the slide align with the first indication line and the second indication line respectively, to adjust an elastic compression of the two elastic members to the optimum value, to provide the best judgment basis for a beginner or an inexperienced person; and
the first indication line and the second indication line are arranged above the receiving space of the holder.

5. The tube cutter as claimed in claim 4, wherein the slide has an inverted L-shaped profile, and the slide is provided with two positioning shafts for mounting the two elastic members.

6. The tube cutter as claimed in claim 4, wherein the slide has a block shape, and the slide is provided with two spring grooves for mounting the two elastic members.
